(19) United States
(12) Patent Application Publication
(10) Pub. No.: US 2018/0356785 A1
(43) Pub. Date: Dec. 13, 2018

(54) METHOD AND DEVICE FOR MONITORING CLOSED-LOOP CONTROL SYSTEM, AND CLOSED-LOOP CONTROL SYSTEM

(71) Applicant: OUR UNITED CORPORATION, Xi'an (CN)

(72) Inventor: Xiaojun Yue, Xi'an (CN)

(21) Appl. No.: 16/104,960

(22) Filed: Aug. 20, 2018

Related U.S. Application Data
(63) Continuation of application No. PCT/CN2017/073241, filed on Feb. 10, 2017.

(30) Foreign Application Priority Data
Feb. 19, 2016 (CN) 201610093730.X

(51) Int. Cl. G05B 19/048

(52) U.S. Cl. CPC G05B 19/048; G05B 2219/24015; G05B 2219/24065

(57) ABSTRACT

The present invention discloses a method and device for monitoring a closed-loop control system and a closed-loop control system. The method comprises: acquiring a motion information value of a servo motor of the closed-loop control system in real time; comparing the motion information value with a corresponding preset threshold during the period T, and controlling the closed-loop control system to be closed when the motion information value is greater than the preset threshold; wherein T is the time required for the actuator of the closed-loop control system to complete the motion; and the preset threshold is a maximum motion threshold of the servo motor during the period T. The present invention can stop the operation of the machine when the galloping phenomenon is about to occur in the closed-loop control system, avoiding loss caused by machine damage.

### TECHNICAL FIELD

The present invention relates to the field of automatic control, and in particular to a method and device for monitoring a closed-loop control system, and a closed-loop control system.

### BACKGROUND

The control mode of a servo unit comprises open-loop control and closed-loop control. The open-loop control system is mainly used in occasions where the control position accuracy is not high. If there is a certain control accuracy requirement, the closed-loop control system needs to be selected.

However, in the event of a feedback disconnection in the closed-loop control system (such as cable disconnection, poor feedback line contact, faulty feedback line connection during commissioning, etc.), the closed-loop control system will experience a galloping phenomenon (high-speed loss of control). At present, in order to achieve the purpose of safety and reliability, various manufacturers basically adopt a safety limit switch or a controller position monitoring method to prevent the galloping phenomenon in the closed-loop control system in order to avoid the above phenomenon. The above method is based on the fact that after the actual galloping phenomenon, the servo motor and the control shaft completely stop from the high speed during galloping, which requires a long movement time. During this period, machine components are often damaged, resulting in property damage.

### SUMMARY

Embodiments a method and device for monitoring a closed-loop control system, and a closed-loop control system, which can stop the operation of the machine when the galloping phenomenon is about to occur in the closed-loop control system, avoiding loss caused by machine damage.

Some embodiments, the present can provide a method for monitoring a closed-loop control system, comprising:

Acquiring a motion information value of a servo motor of the closed-loop control system in real time;

comparing the motion information value with a corresponding preset threshold during the period T; and

controlling the closed-loop control system to be closed when the motion information value is greater than the preset threshold;

wherein T is the time required for the actuator of the closed-loop control system to complete the motion; and the preset threshold is a maximum motion threshold of the servo motor during the period T.

The present invention in some embodiments provides a device for monitoring a closed-loop control system, comprising a processor, wherein the processor is configured to execute the following functional modules:

an acquiring module configured to acquire a motion information value of a servo motor of the closed-loop control system in real time;

a comparing module configured to compare the motion information value with a corresponding preset threshold during the period T; and

a control module configured to control the closed-loop control system to be closed when the motion information value is greater than the preset threshold;

wherein T is the time required for the actuator of the closed-loop control system to complete the motion; and the preset threshold is a maximum motion threshold of the servo motor during the period T.

Different from the prior art, the method for monitoring the closed-loop control system according to the present invention monitors the operating state of the servo motor of the closed-loop control system in real time during the operation of the closed-loop control system, and timely controls the closed-loop control system to be closed when the servo motor operates abnormally, effectively avoiding the occurrence of the galloping phenomenon and avoiding loss caused by machine damage.

### BRIEF DESCRIPTION OF THE DRAWINGS

FIG. 1 is a schematic diagram illustrating the flow of a method for monitoring a closed-loop control system according to the present invention.

FIG. 2 is a schematic diagram illustrating the structure of a device for monitoring a closed-loop control system according to the present invention.

FIG. 3 is a schematic diagram illustrating the structure of an embodiment of a closed-loop control system according to the present invention.

FIG. 4 is a schematic diagram illustrating the structure of another embodiment of a closed-loop control system according to the present invention.

### DESCRIPTION OF THE EMBODIMENTS

The technical solution of the present invention will be in some embodiments described in detail below with reference to specific embodiments. It is apparent that the described embodiments are only a part of the embodiments of the present invention, rather than all of the embodiments. All other embodiments obtained by those skilled in the art based on the embodiments of the present invention without making undue experimentation shall fall within the scope of protection of the present invention.

A full-closed-loop monitoring system and a semi-closed-loop monitoring system are common monitoring systems in the field of automatic control currently. The semi-closed-loop monitoring system monitors the driving link of the final execution link of the whole system, but does not monitor the final executing mechanism; the full-closed-loop monitoring system monitors the final execution link of the whole system, and can compensate for the displacement error caused by any link of the system.

As shown in FIG. 3, the closed-loop control system 1 comprises at least four parts: a control mechanism 101, a servo control mechanism 102, a servo motor 103 and an actuator 104. The control process is usually the motion displacement of the load 105 set by the control mechanism 101 and is transmitted to the servo control mechanism 102. The servo control mechanism 102 converts the motion displacement of the load 105 into the number of revolutions that the servo motor 103 rotates according to the performance and the rotation speed of the servo motor 103. The servo motor 103 rotates according to the number of revolutions of the motor converted by the servo control mechanism 102 to cause the actuator 104 to drive the load 105 to move. After the servo motor 103 rotates for the corresponding number of revolutions, the load 105 is brought to the specified position with the actuator 104. Due to the accuracy of the conversion, when the actuator 104 drives the load 105 to move, it is impossible to accurately reach the specified position since there is often a displacement error. The displacement error is acceptable if it is within a reasonable range. When the displacement error is too large, the feedback link of the closed-loop control system 1 will feed it back to the control mechanism to be reset.

However, in the actual closed-loop control system, the feedback link of the closed-loop control system 1 will be disconnected due to an external force factor, so that the control mechanism 101 cannot obtain a feedback and cannot send a stop instruction to the servo control mechanism 102 and the servo motor 103, or there is a case that the servo motor 103 is not controlled and the galloping phenomenon occurs. The servo motor 103 drives the actuator 104 to continue to move. At this time, it takes a period of time to stop the servo motor 103 running at high speed. During this period, the actuator 104 or the load 105 will hit the device at high speed, resulting in device damage and economic loss.

Therefore, the present invention provides a method for monitoring a closed-loop control system, which is used to stop the operation of the machine when the galloping phenomenon is about to occur in the closed-loop control system, avoiding loss caused by machine damage.

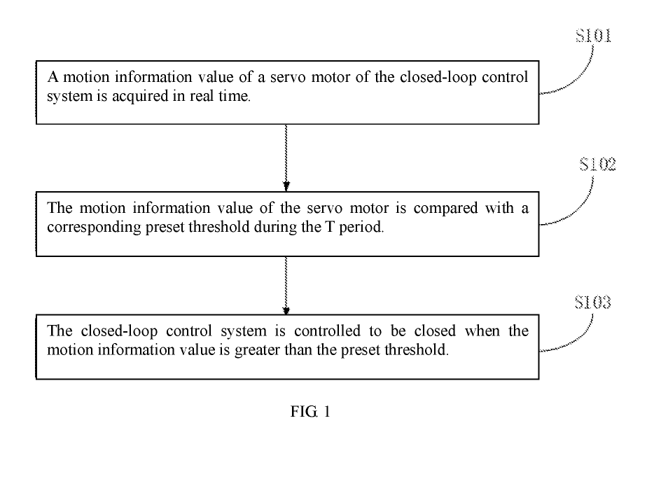

Referring to FIG. 1, FIG. 1 is a schematic diagram illustrating the flow of a method for monitoring a closed-loop control system according to the present invention. The monitoring method comprises the following steps.

S101: A motion information value of a servo motor 103 of the closed-loop control system is acquired in real time.

The motion information value of the servo motor 103 is acquired from the closed-loop control system 1 in real time, comprising the rotation speed information, the number of revolutions, etc., of the servo motor 103, which is not limited by the present invention.

S102: The motion information value of the servo motor 103 is compared with a corresponding preset threshold during the period T.

If the acquired motion information value of the servo motor 103 is a rotation speed information value, the rotation speed of the servo motor 103 is compared with the corresponding rotation speed threshold during the period T.

If the acquired motion information value of the servo motor 103 is an information value of the number of revolutions, the number of revolutions of the servo motor 103 is compared with the corresponding threshold of the number of revolutions during the period T.

Here, the period T refers to: the time required for the actuator 104 of the closed-loop control system to complete the motion. The time required for the actuator 104 to complete the motion may be calculated according to the number of revolutions of the servo motor 103 of the closed-loop control system and the position where the actuator 104 needs to move, i.e., T.

The preset threshold refers to the maximum motion threshold of the servo motor 103 of the closed-loop control system during the period T, that is, when the acquired motion information value of the servo motor 103 is the rotation speed information value, the corresponding preset threshold is the maximum rotation speed of the servo motor 103 during the period T; when the acquired motion information value of the servo motor 103 is the information value of the number of revolutions, the corresponding preset threshold is the maximum number of revolutions of the servo motor 103 during the period T.

S103: The closed-loop control system 1 is controlled to be closed when the motion information value is greater than the preset threshold.

For example, the acquired motion information value is the rotation speed information value of the servo motor 103. When the servo motor 103 rotates to drive the load 105 controlled by the closed-loop control system 1 to move to the specified position, the rotation speed of the servo motor 103 undergoes a process from being slow to being fast and then to being slow. If the rotation speed of the servo motor 103 continues to rise after reaching the maximum rotation speed of the servo motor 103 preset during the period T, the motion displacement of the load 105 will inevitably exceed the preset motion displacement, resulting in the galloping phenomenon and device damage. Therefore, if it is found by comparison that the rotation speed of the servo motor 103 acquired in real time is greater than the preset rotation speed threshold, it is determined that a galloping phenomenon is about to occur in the closed-loop control system 1. At this time, the closed-loop control system 1 is controlled to be closed, that is, the galloping phenomenon may be avoided by controlling the rotating shaft of the servo motor 103 to stop rotating.

The period T and the preset threshold described above are determined according to the size of a load 105 and the movement speed of a load 105 controlled by the closed-loop control system 1, and in different closed-loop control systems 1, the above preset values are different from each other.

Therefore, the present invention monitors the operating state of the servo motor of the closed-loop control system in real time during the operation of the closed-loop control system, and timely controls the closed-loop control system to be closed when the servo motor operates abnormally, effectively avoiding the occurrence of the galloping phenomenon.

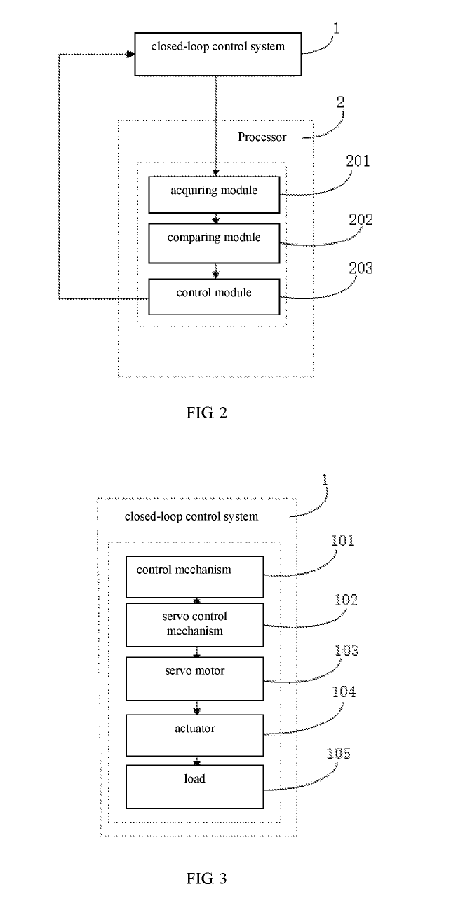

The present invention in some embodiments provides a device for monitoring a closed-loop control system. Referring to FIG. 2, the device comprises a processor 2, wherein the 2 is configured to execute the following functional modules:

an acquiring module 201 configured to acquire a motion information value of a servo motor 103 of the closed-loop control system 1 in real time;

a comparing module 202 configured to compare the motion information value with a corresponding preset threshold during the period T; and

a control module 203 configured to control the closed-loop control system 1 to be closed when the motion information value is greater than the preset threshold;

wherein T is the time required for the actuator 104 of the closed-loop control system 1 to complete the motion; and the preset threshold is a maximum motion threshold of the servo motor 103 during the period T.

The motion information value of the servo motor 103 may be a rotation speed information value, an information value of the number of revolutions, etc. Correspondingly, the preset threshold is a maximum rotation speed, a maximum revolving speed, etc., of the servo motor 103 during the period T, which is not limited by the present invention.

The period T and the preset threshold described above are determined according to the size of a load 105 and the movement speed of a load 105 controlled by the closed-loop control system 1, and in different closed-loop control systems 1, the above preset values are different from each other.

In this embodiment, the processor 2 is a Central Processing Unit (CPU), or an Application Specific Integrated Circuit (ASIC), or one or more integrated circuits configured to implement the embodiment of the present application, such as one or more Digital Signal Processors (DSPs), or one or more Field Programmable Gate Arrays (FPGAs).

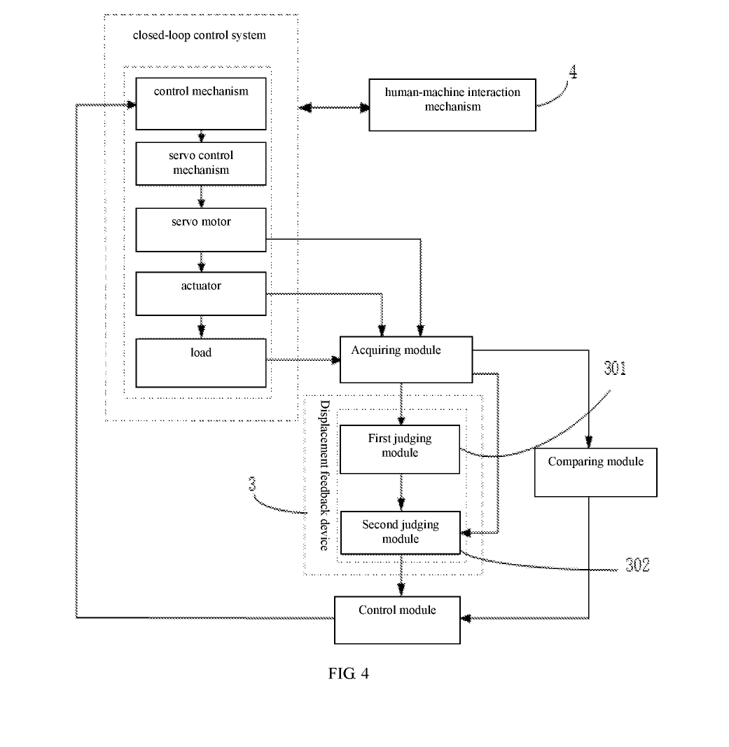

In addition, the present invention in some embodiments provides a closed-loop control system, as shown in FIG. 4, comprising: a displacement feedback device 3 and the device for monitoring a closed-loop control system described above. The displacement feedback device 3 is configured to control the load 105 controlled by the closed-loop control system 1 to move to the specified position.

Specifically, the displacement feedback device 3 is provided in parallel with the monitoring device, comprising a first judging module 301 and a second judging module 302. The first judging module 301 and the second judging module 302 are both connected to the acquiring module 201 and the control module 203.

The acquiring module 201 and the control module 203 are preferably the same modules as the acquiring module and the control module in the device for monitoring a closed-loop control system. It is to be understood that the module may also be an independent module.

The acquiring module 201 is connected to the closed-loop control system 1, acquires a displacement controlled by the closed-loop control system 1 that the load 105 moves with the actuator 104 (not shown) in real time from the closed-loop control system 1, and acquires a displacement error generated when the load 105 moves with the actuator 104 at the same time.

The first judging module 301 acquires the displacement error data acquired by the acquiring module 201, and sets a first preset value according to a conventional control operation, wherein the first preset value is a minimum displacement error value that affects the operation of the closed-loop control system 1. When the displacement error value exceeds the minimum displacement error value, it is necessary to stop the operation of the closed-loop control system 1 for adjustment. The closed-loop control system 1 calculates the time required for the actuator 104 to complete the movement according to the number of revolutions of the servo motor 103 and the moving displacement of the actuator 104, and records the time as T. The first judging module 301 compares the acquired displacement error value with the first preset value in the T time. When it is determined that the displacement error value is greater than the first preset value, the second judging module 302 is started.

The second judging module 302 obtains the measurement displacement according to the displacement error value and the moving displacement acquired by the acquiring module 201. It can be seen according to the data of the conventional operation process that the measurement displacement is equal to the difference between the set moving displacement and the acquired displacement error value theoretically. Therefore, the measurement displacement may be obtained by the foregoing calculation or directly read from the control mechanism 101 of the closed-loop control system 1. In the present embodiment, the closed-loop control system 1 takes the distance that the load 105 actually moves as the measurement displacement. At the same time, the second judging module 302 sets a second preset value. The second preset value is the displacement set by the control mechanism 101 of the closed-loop control system 1 that the load 105 moves with the actuator 104. The second judging module 302 compares the calculated measurement displacement with the second preset value in the T time. When the measurement displacement is greater than the second preset value, the control module 203 transmits an instruction to the closed-loop control system 1 to close the power, stop the operation of the servo motor 103, stop the movement of the load 105, and ensure that the load 105 can be moved to the specified position, that is, accurately in place.

When the closed-loop control system 1 is in operation, the displacement feedback device 3 will feed back the motion of the load 105 to the control mechanism 101 in real time. The control mechanism 101 determines according to the data fed back by the displacement feedback device 3 whether the load 105 has completed the movement according to the instruction, and controls the operation of the servo motor 103 so as to ensure that the load 105 is accurately in place; at the same time, the device for monitoring a closed-loop control system determines the operating condition of the closed-loop control system 1 according to the motion information of the servo motor 103 of the closed-loop control system. When the closed-loop control system 1 operates normally, the device for monitoring a closed-loop control system has no output.

However, when the feedback link of the closed-loop control system 1 is disconnected (i.e., the link between the acquiring module 201 and the position feedback device is disconnected in FIG. 4), the control mechanism 101 cannot obtain the actual feedback data, the rotation speed of the servo motor 103 is always increased, and the actuator 104 drives the load 105 to accelerate, which may cause damage to the machine device. At this time, when detecting that the closed-loop control system 1 operates abnormally, the device for monitoring a closed-loop control system outputs data to the control module 203 in time. The control module 203 issues a stop instruction to the closed-loop control system 1, so that the servo motor 103 of the closed-loop control system stops operating, and the load 105 stops moving, avoiding the occurrence of a galloping phenomenon.

Further, the closed-loop control system 1 in some embodiments comprises a human-machine interaction mechanism 4 configured to provide a visual interface for reading or setting data. The human-machine interaction mechanism 4 may be a computer.

The above closed-loop control system 1 may be applied to a radiotherapy device. For example, the above closed-loop control system 1 may be applied to the control of an on/off-source mechanism of a radiotherapy device. Specifically, the control mechanism 101 is connected to an off-source mechanism (not shown), so that the control mechanism 101 sends a shutoff instruction to the off-source mechanism. The off-source mechanism is preferably a monitoring software. The closed-loop control system is used in a radiotherapy system comprising at least one treatment head. The control mechanism 101 is connected to an off-source mechanism (not shown) of the radiotherapy device. If the device for monitoring a closed-loop control system determines during the period T that the rotation speed of the servo motor 103 is greater than a preset threshold, the device for monitoring a closed-loop control system outputs an instruction, and the control mechanism 101 controls the off-source mechanism to close the radiotherapy head (not shown) of the radiotherapy device while stopping the rotation of the radiotherapy head.

Different from the prior art, the device for monitoring the closed-loop control system according to the present invention acquires a motion information value of the servo motor of the closed-loop control system, compares the motion information value of the servo motor with the preset threshold in the set period, and sends a shutoff instruction to the closed-loop control system when the motion information value of the servo motor is greater than the preset threshold. The device for monitoring the closed-loop control system can stop the operation of the machine when the galloping phenomenon is about to occur in the closed-loop control system, avoiding loss caused by machine damage.

The above description is only the embodiment of the present invention, and is not intended to limit the patent scope of the present invention. All the equivalent structure or equivalent process changes which are made using the specification and the drawings of the present invention and are directly or indirectly applied to other related technical fields are included in the scope of patent protection of the present invention.

What is claimed is:

1. A method for monitoring a closed-loop control system, comprising:
acquiring a motion information value of a servo motor of the closed-loop control system in real time;
comparing the motion information value with a corresponding preset threshold during a period T; and
controlling the closed-loop control system to be closed when the motion information value is greater than the preset threshold; and, wherein
T is the time required for the actuator of the closed-loop control system to complete the motion; and
the preset threshold is a maximum motion threshold of the servo motor during the period T.

2. The monitoring method according to claim 1, wherein the motion information value of the servo motor is the rotation speed of the servo motor.

3. The monitoring method according to claim 2, wherein the preset threshold is a preset maximum rotation speed of the servo motor during the period T.

4. The monitoring method according to claim 1, wherein the period T and the preset threshold are determined according to a size and a movement speed of a load controlled by the closed-loop control system.

5. A device for monitoring a closed-loop control system, comprising a processor, wherein the processor is configured to execute the following functional modules:
an acquiring module configured to acquire a motion information value of a servo motor of the closed-loop control system in real time;
a comparing module configured to compare the motion information value with a corresponding preset threshold during the period T; and
a control module configured to control the closed-loop control system to be closed when the motion information value is greater than the preset threshold; and, wherein
T is the time required for the actuator of the closed-loop control system to complete the motion; and
the preset threshold is a maximum motion threshold of the servo motor during the period T.

6. The monitoring device according to claim 5, wherein the motion information value of the servo motor is a rotation speed of the servo motor.

7. The monitoring device according to claim 6, wherein the preset threshold is a preset maximum rotation speed of the servo motor during the period T.

8. The monitoring device according to claim 5, wherein the period T and the preset threshold are determined according to a size and a movement speed of a load controlled by the closed-loop control system.

9. A closed-loop control system, comprising: a displacement feedback device and the monitoring device according to claims 5, wherein the displacement feedback device is configured to control the load controlled by the closed-loop control system to move to the specified position.

10. The closed-loop control system according to claim 9, further comprising a human-machine interaction mechanism configured to provide a visual interface for reading or setting data.
